(19) United States
(12) Patent Application Publication
(10) Pub. No.: US 2007/0058070 A1
(43) Pub. Date: Mar. 15, 2007

(54) Zoom camera

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng (TW)

(21) Appl. No.: 11/400,885

(22) Filed: Apr. 10, 2006

(30) Foreign Application Priority Data
Sep. 9, 2005 (CN) 200510037221.7

(51) Int. Cl. H04N 5/225

(52) U.S. Cl. 348/340

(57) ABSTRACT

A zoom camera (100) includes a first lens barrel (10), at least one first lens (12) positioned in the first lens barrel, a second lens barrel (20), at least one second lens (22) positioned in the second barrel, an image pickup module (60) and an actuator (40). The first lens defines an optical axis, and the second lens is coaxially aligned with the first lens. The image pickup module is arranged adjacent the second lens barrel. The actuator is attached to the second lens barrel and includes a shape memory alloy configured for moving the second lens barrel along the optical axis. The present zoom camera is small in volume and consumes little power. Therefore, the present zoom camera is suitable to be used in mobile phone or PDA, which needs to be small and have low power consumption.

### BACKGROUND

1. Field of the Invention

The present invention relates generally to cameras, and more particularly, to a zoom camera, for example, a small-sized digital camera with a zoom function, or a portable electronic device, such as a mobile phone or a Personal Digital Assistant (PDA), which has a digital camera incorporated therein.

2. DISCUSSION OF THE RELATED ART

Recently, with the development of wireless communication technologies, there are many cases where digital cameras are mounted in mobile phones or PDAs.

Generally, digital cameras are image recording media capable of photographing a plurality of still images without using film. Such a digital camera typically uses an image pickup module, which is a kind of semiconductor device, such as a Charge Coupled Device (CCD) or Complementary Metal Oxide Semiconductor (CMOS). In the digital camera, an object image formed on the image pickup device through a lens is converted into an electrical signal by the image pickup device, and the electrical signal is stored as a digital signal in a mobile phone or PDA in which the digital camera is mounted.

Since the digital camera is desirably to be mounted in small-sized mobile phones or PDAs, a fixed focus lens module is usually used to facilitate mounting thereof within a small-sized mobile phone or PDA. However, images photographed by a digital camera module with a fixed focus lens module tend to be poor in quality This is partly due to the fixed focus lens, which is incapable of adjusting focal length to make a good-quality image.

A conventional digital camera with a zoom function usually uses an actuator such as step motor to drive the lens module. But the digital camera using such a step motor is relatively large in volume and consumes a substantial amount of power, especially relative to the amount of power that can be stored in the typical battery system of a mobile phone or PDA. As such, a step motor is not suitable to be used in a mobile phone or PDA, which needs to be small and have low power consumption.

What is needed, therefore, is a digital camera module with a zoom function which satisfies the needs for performance enhancement, downsizing and power saving.

### SUMMARY

A zoom camera according to one preferred embodiment includes a first lens barrel, at least one first lens positioned in the first lens barrel, a second lens barrel, at least one second lens positioned in the second lens barrel, an image pickup module and an actuator. The first lens defines an optical axis, and the second lens is coaxially aligned with the first lens. The image pickup module is arranged adjacent to the second lens barrel. The actuator is attached to the second lens barrel and includes a shape memory alloy configured for moving the second lens barrel along the optical axis.

A zoom camera according to another preferred embodiment includes a first lens barrel, at least one first lens positioned in the first lens barrel, a second lens barrel, at least one second lens positioned in the second lens barrel, an image pickup module and a plurality of actuators. The first lens defines an optical axis, and the second lens is coaxially aligned with the first lens. The image pickup module is arranged adjacent the second lens barrel. The plurality of actuators are attached to the second lens barrel and each one includes a shape memory alloy configured for moving the second lens barrel along the optical axis.

Compared with conventional zoom camera, the present zoom camera has following advantages. Because the actuator includes a shape memory alloy, the shape memory alloy has a dimension changeable in the direction of the optical axis so as to move the second lens barrel along the optical axis. Thus the second lens barrel is made zoomable. The actuator with the shape memory alloy is small in volume and consumes little power. Therefore, the present zoom camera is suitable to be used in mobile phone or PDA, which needs to be small and have low power consumption.

Other advantages and novel features will become more apparent from the following detailed description of present zoom camera, when taken in conjunction with the accompanying drawings.

### BRIEF DESCRIPTION OF THE DRAWINGS

Many aspects of the present zoom camera can be better understood with reference to the following drawings. The components in the drawings are not necessarily drawn to scale, the emphasis instead being placed upon clearly illustrating the principles of the present zoom camera. Moreover, in the drawings, like reference numerals designate corresponding parts throughout the several views.

FIG. 1 is a schematic, cross-sectional view of a zoom camera in accordance with a preferred embodiment; and

FIG. 2 is a schematic view showing a solid state phase transformation of a shape memory alloy of FIG. 1.

### DETAILED DESCRIPTION OF PREFERRED EMBODIMENTS

Reference will now be made to the drawings to describe preferred embodiments of the present zoom camera, in detail.

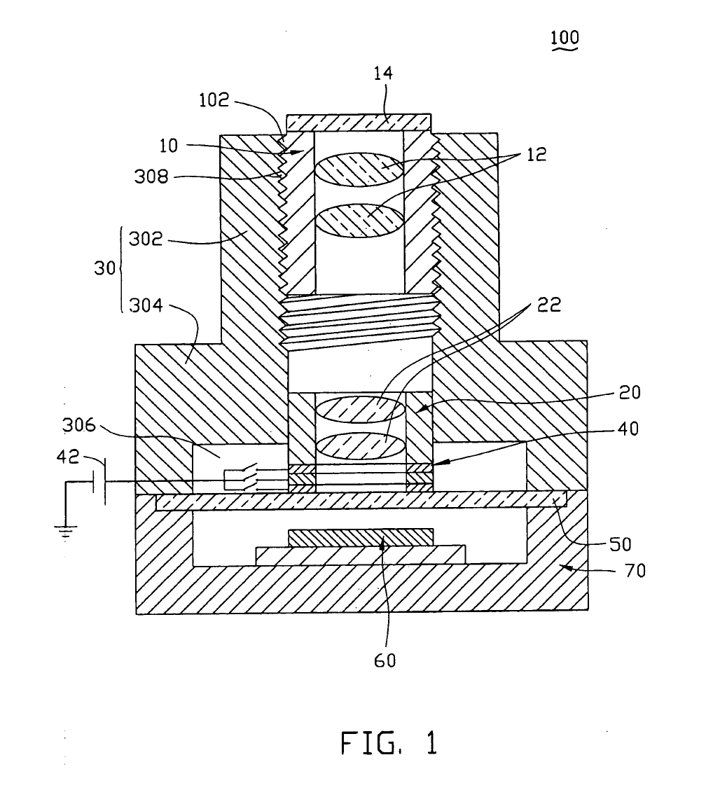

Referring to FIG. 1, a zoom camera 100, in accordance with a first preferred embodiment, is shown. The zoom camera module 100 includes a first lens barrel 10, a second lens barrel 20, a housing 30, an actuator 40, a transparent board 50, an image pickup device 60 and a base 70.

The first lens barrel 10 is a hollow cylinder. At least one first lens 12 is positioned in the first lens barrel 10 and the first lens 12 defines an optical axis. A cover 14 is attached to the first barrel 10. The cover 14 is a transparent plate, such as a glass plate. Thus light beams can be transmitted therethrough with the first lens 12 protected from external pollution or contamination. The first lens barrel 10 has an external thread 102 on the outside thereof.

The second lens barrel 20 is also a hollow cylinder. At least one second lens 22 is positioned in the second lens 20, and the second lens 22 is coaxially aligned with the first lens. The second lens barrel 20 is set between the first barrel 10 and the image pickup device 60.

The housing 30 includes a holder 302 and a holder bottom 304. The holder 302 is a hollow cylinder. The holder bottom 304 is a cube. The holder bottom 304 is disposed at an end of the holder 302 and defines a rectangular opening 306 in the center thereof. The rectangular opening 306 is in communication with the receiving the cavity of the holder 302. The external thread 102 of the first lens barrel 10 corresponds to internal thread 308 of the holder 302. The holder 302 is in threaded engagement with the first lens barrel 10. The first lens barrel 10 and the second lens barrel 20 are received in the housing 30.

The actuator 40 is arranged adjacent the second barrel 20. The actuator 40 is interposed between the second lens barrel 20 and the transparent board 50. The actuator 40 is a hollow cylinder formed with a shape memory alloy, and a size of the actuator 40 corresponds to that of the second lens barrel 20.

The shape memory alloy is a metal, which exhibits two very unique properties, pseudo-elasticity and the shape memory effect. The two unique properties are made possible through a solid state phase transformation occurring in the shape memory alloy The solid state phase transformation is similar in that molecular rearrangement is occurring, but the molecules remain closely packed so that the shape memory alloy remains a solid.

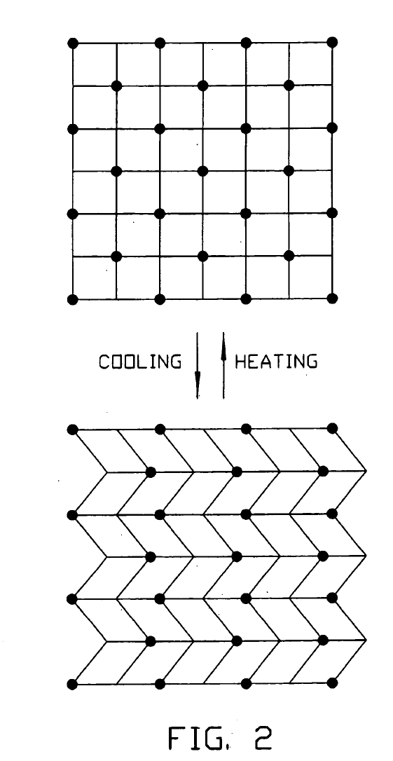

Referring to FIG. 2, when the shape memory alloy is under normal temperature, it is in its Martensite phase. As the shape memory alloy is heated to a certain temperature, it enters its Austenite phase where its inner molecules rearrange, but it remains a solid. When the shape memory alloy stops being heated, it cools and returns to its Martensite phase. When the shape memory alloy changes from Austenite phase to Martensite phase, the shape memory alloy has a dimension changeable in the direction of the optical axis so as to move the second lens barrel 20 along the optical axis. In this embodiment, the shape memory alloy is heated by a heater which is in turn powered by a power supply 42.

Alternatively, a plurality of actuators 40 could be used, and they are stacked one on another. Each actuator 40 is electrically connected with a power supply 42, and each actuator 40 is utilized as one independent control unit. The amount of the actuators 40 being heated can be controlled by controlling the power supply 42. An insulated film (not shown) is arranged between every two actuators 40 for preventing heat transmission. Additionally, a cooling device, for example a heat pipe and/or a heat sink (not shown) could be disposed adjacent the actuators 40 for accelerating cooling so that the actuators 40 can return to their Martensite phase quickly.

The shape memory alloy can be made from Cu—Al—Fe alloy, Cu—Al—Ni, Ni—Ti alloy, Cu—Ni—Ti alloy, Cu—Zr—Zn alloy, Cu—Al—Zn alloy, Cu—Al—Fe—Zn alloy, Ni—Ti—Al—Cu alloy, Ni—Ti—Al—Zn alloy, Ni—Ti—Al—Zn—Cu alloy, and any combination alloy thereof (where Cu is copper, Al is aluminium, Fe is iron, Ni is nickel, Ti is titanium, Zr is zirconium and Zn is zinc). These shape memory alloys have excellent shape memory properties, and consume little power.

The transparent board 50 is mounted on the base 70, for supporting the actuator 40 thereon. The transparent board 50 is arranged on the image pickup device 60 for protecting the image pickup device 60 from external pollution or contamination. The transparent board 50 is made of glass so that light beams can transmit therethrough. Preferably, an IR-cut coating (not shown) is deposited on the transparent board 50 for blocking infrared rays so that the quality of the images can be improved.

The base 70 is connected with the housing 30. The image pickup module 60 is mounted on the base 70. The image pickup module 60 is usually a charge coupled device (CCD) or a complementary metal-Oxide semiconductor (CMOS) for converting a light signal of an image to an electrical signal.

When the zoom camera 100 working, the actuator 40 is controlled by controlling the power supply 42 for moving the second barrel 20 along the optical axis. Focus changes as the second barrel 20 moves.

Because the actuator 40 includes a shape memory alloy, the shape memory alloy can change length in the direction of the optical axis so as to move the second lens barrel 20 along the optical axis. Thus the zoom camera 100 can performance a zoom function. The actuator 40 having the shape memory alloy is small in volume and consumes little power. Therefore, the present zoom camera is suitable to be used in mobile phone or PDA, which needs to be small and have low power consumption.

The actuator 40 could also be arranged adjacent the image pickup module 60 to move the image pickup module 60 along the optical axis thus performing an auto-focusing function.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A zoom camera comprising:
a first lens barrel;
at least one first lens positioned in the first lens barrel, the first lens defining an optical axis;
a second lens barrel;
at least one second lens positioned in the second lens barrel, the second lens being coaxially aligned with the first lens;
an image pickup module arranged adjacent the second lens; and
an actuator attached to the second lens barrel, the actuator comprising a shape memory alloy configured for moving the second lens barrel along the optical axis.

2. The zoom camera as claimed in claim 1, wherein the shape memory alloy has a dimension changeable in the direction of the optical axis so as to move the second lens barrel along the optical axis.

3. The zoom camera as claimed in claim 2, further comprising a heater configured for heating the shape memory alloy and thereby effecting a solid state phase transformation of the shape memory alloy so as to change the dimension of the shape memory alloy in the direction of the optical axis.

4. The zoom camera as claimed in claim 3, further comprising a power supply, the heater is electrically connected with the power supply.

5. The zoom camera as claimed in claim 1, wherein the shape memory alloy is selected from a group consisting of Cu—Al—Fe alloy, Cu—Al—Ni alloy, Ni—Ti alloy, Cu—Ni—Ti alloy, Cu—Zr—Zn alloy, Cu—Al—Zn alloy, Cu—Al—Fe—Zn alloy, Ni—Ti—Al—Cu alloy, Ni—Ti—Al—Zn alloy, Ni—Ti—Al—Zn—Cu alloy, and any combination alloy thereof.

6. The zoom camera as claimed in claim 1, further comprising a housing, the first lens barrel and the second lens barrel being received in the housing.

7. The zoom camera as claimed in claim 1, further comprising a transparent plate, the actuator being interposed between the second lens barrel and the transparent plate.

8. The zoom camera as claimed in claim 7, further comprising a base with the transparent board mounted thereon.

9. The zoom camera as claimed in claim 1, wherein the image pickup module comprises one of a charge coupled device and a complementary metal-oxide semiconductor.

10. The zoom camera as claimed in claim 1, further comprising a cover attached on the first lens barrel.

11. The zoom camera as claimed in claim 10, wherein the cover is a transparent plate.

12. The digital camera as claimed in claim 10, wherein the cover is made of glass.

13. A zoom camera comprising:
a first lens barrel;
at least one first lens positioned in the first lens barrel, the first lens defining an optical axis,
a second lens barrel;
at least one second lens positioned in the second lens barrel, the second lens being coaxially aligned with the first lens;
an image pickup module arranged adjacent the second lens; and
a plurality of actuators attached to the second lens barrel, the actuators each comprising a shape memory alloy configured for moving the second lens barrel along the optical axis.

14. The zoom camera as claimed in claim 13, wherein the actuators are stacked one on another.

15. The zoom camera as claimed in claim 13, wherein the shape memory alloy has a dimension changeable in the direction of the optical axis so as to move the second lens barrel along the optical axis.

16. The zoom camera as claimed in claim 15, further comprising a heater configured for heating the shape memory alloy and thereby effecting a solid state phase transformation of the shape memory alloy so as to change the dimension of the shape memory alloy in the direction of the optical axis.

17. The zoom camera as claimed in claim 16, further comprising a power supply, the heater shape memory alloy being electrically connected with the power supply.

18. The zoom camera as claimed in claim 13, wherein the shape memory alloy is selected from a group consisting of Cu—Al—Fe alloy, Cu—Al—Ni alloy, Ni—Ti alloy, Cu—Ni—Ti alloy, Cu—Zr—Zn alloy, Cu—Al—Zn alloy, Cu—Al—Fe—Zn alloy, Ni—Ti—Al—Cu alloy, Ni—Ti—Al—Zn alloy, Ni—Ti—Al—Zn—Cu alloy, and any combination alloy thereof.
